(19) United States
(12) Patent Application Publication
(10) Pub. No.: US 2004/0213222 A1
(43) Pub. Date: Oct. 28, 2004

(54) Buffer for use in electronic device including asynchronous transfer mode (ATM) switching capabilities or including interior fixed length packet/cell processing

(76) Inventors: Eyal Assa, Hod Hasharon (IL); David Berechya, Tel Mond (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 09/767,196

(22) Filed: Jan. 22, 2001

(51) Int. Cl. H04L 12/56; H04L 12/28

(52) U.S. Cl. 370/389; 370/412; 370/395.1

(57) ABSTRACT

An Electronic device including Asynchronous Transfer Mode (ATM) switching capabilities or including interior fixed length packet/cell processing for use in telecommunication networks. The electronic device includes a buffer of incoming cells of packets, the cells are assigned, each within Virtual Path Identifier (VPI) and Virtual Channel Identifier (VCI), such that all cells of the same packet bear the same VCI. Each VCI is associated with data that include data item serving for packet efficiency mechanism. The device further includes storage medium storing data representative of data structure for storing selected number from the specified data items. The device further includes processor associated with the storage medium that is configured to perform the processing procedures that include: for each incoming cell whose VCI is associated with data item that is stored in the data structure constructing a search key that enables to access said data item at substantially O(1).

### FIELD OF THE INVENTION

The present invention is in the general field of buffer for use in electronic device including asynchronous transfer mode (ATM) switching capabilities or including interior fixed length packet/cell processing.

### BACKGROUND OF THE INVENTION

In packet communication, the data is packed in packets. Each packet contains data and overhead parts that are used for, e.g. routing information, error detection and for other administration information. An example of packet communication protocol is IP (Internet Protocol). There are many other protocols that are based on packet communication. In most of the packet communication protocols (one example is TCP/IP), only complete packets can be processed and accordingly if the receiving side gets an incomplete packet, there is a need to retransmit the packet. The re-transmission process is successfully terminated when the packet is eventually received in a complete form at the receiver side.

When packets are conveyed in Asynchronous Transfer Mode (ATM) network, for example in IP over ATM, the packet (See (10) FIG. 1-(a)) is segmented into cells (e.g. cell (11) in FIG. 1-(b)). The cell (12) that contains the trailer of the packet is marked as EOF (End Of Frame). It should be noted that in the context of the invention the terms “frame” and “packet” are used interchangeably.

The packet communication over ATM is operative in distinct Virtual Path (VP) and Virtual Channel (VC) communication modes.

1. As shown in FIG. 2a, VC contains cells from sequential packets. Thus, cells A1 to A4 of packet A are followed by B1 to B2 of packet B, which in turn are followed by C1 to C2 of packet C.

2. VP is a combination of VCs, the cells in the VP belong to different packets (different VCs) and are randomly interleaved. As shown in the example of FIG. 2B, cells from different packets are interleaved, e.g. cell A1 (21) that belongs to packet A, followed by cell B1 (22) that belongs to packet B, followed by cell C1 that belongs to packet C. The respective EOF cells are designated as (24), (25) and (26).

FIG. 3 illustrates a typical ATM architecture where cell buffer (31) is incorporated in an ATM node (32). The buffer is aimed at absorbing burst of cells that come in input rate greater than output rate.

As specified above, uncompleted packets are useless. In FIG. 4(a) there is shown an example of a simple buffer without any mechanism of improving packet efficiency. Cells are fed to the buffer in input rate equal twice the output rate and seeing that the input rate is greater then the output rate, the buffer becomes full. At this point cells will be discarded at the output of the buffer which results in many uncompleted packets. FIG. 4(b) illustrates an example of a buffer with packet efficiency mechanism. Assuming that the scenario of FIG. 4(a) applies, the packet efficiency mechanism is configured to discard every second packet instead of every second cell as done in the simple buffer. Thus, whereas in the simple buffer mechanism cells C1 (41 and 42) that belong to respective packets F1 and F2 are outputted (rendering both incomplete F1 and F2 packets useless due to the missing C2 cells), in accordance with the packet efficiency mechanism of FIG. 4B, the cells of the first complete packet F1 (C1 (43) and C2 (44)) are outputted and the cells of F2 (45 and 46) are discarded. To sum up, whereas in the simple buffer mechanism both packets were discarded, with the efficient buffer mechanism only F2 is discarded. It should be noted that for simplicity, the specified description refers to distinct cells, however, it is understood that in a typical data stream with many packets there is loss of many packet which require retransmission due to the shortcomings of the specified poor packet efficiency mechanism.

There is a well-known method called EPD/PPD (Early Packet Discard/Partially packet Discard) which serves as packet efficiency mechanism. It generally works like this; if cells that belong to a certain packet were dropped or otherwise lost because of congestion (or another reasons) the entire packet is rendered useless, and accordingly there is no point in processing the rest of the cells of this packet and thus they will be discarded. The difference between EPD and PPD is as follows: in EPD, if the first cell in the frame was dropped the rest of the cells will be dropped. In PPD, if the first cell that dropped was in the middle of the frame, the rest of the cells will be dropped except the last cell in the frame (the cell with EOF marked), the reason for passing the last cell is to enable the receiver to delineate the defect packet.

A typical EPD/PPD on a VC mechanism is based on the following:

two thresholds are utilized, one for EPD and one for PPD in order to determine whether to accept a cell or to discard it. When the EPD threshold is surpassed no new frames will be accepted to the buffer. Put differently, cells that belong to a frame that none of its cells are in the buffer will be discarded, and only cells that belong to a frame that one or more of its cells are already in the buffer will be accepted. When the PPD threshold is crossed no cell will be accepted to the buffer.

FIG. 5 illustrates the state's transitions (50) that controls EPD/PPD thresholds (referred to also as EPD/PPD state machine). When the EPD/PPD option is enabled (state 10 (51)), the Buffer Manager (BM) checks for the first cell of a packet. If the EPD (low) threshold has not been reached, the first cell is accepted and the state machine is transited to state 00 (52) through link (53). The BM will now accepts all coming cells of this frame, while it uses the PPD (high) threshold. Reverting now to state (50), if the first cell is not accepted (using the low threshold) the state machine transits to state 11 (54) through link (55), and in this state all other cells of this frame are discarded. Reverting now to state 00 (52), in the case the BM accepts the first cell and it discards other cell in the fame the state machine transits to state (56) through link (57) and now all other cells of this frame will be discarded, except for the last cell. The last cell will be checked with the PPD threshold and will result in reverting to the start state (51) through links (58), (59) or (60), depending upon the current state (56, 52 or 54, respectively). As readily arises from the discussion above, the EPD/PPD on a VC stream can be implemented using two bits data structure (for representing the four states 00, 01, 10 and 11).

In the case of VC switch, the switch is configured with the VPI/VCI identifier and the stream is totally recognized. In case of VP switch, the switch is configured with the VPI only and inside the VPI there could be numerous VCIs. The switch is not given any information on the number of VCs or on the value of the VCIs they have. The fact that EPD/PPD is valid only for VCs and the fact that in VP switch there is no information of the inside VCs lead to the current situation in the art that the throughput of packetized streams over ATM which are running inside a VP switch is not given an answer. There is thus a need in the art to provide for a mechanism to have EPD/PPD on VCs inside VPs which are VP switched.

It is thus known how to implement EPD/PPD state machine for a VC with two bits. Accordingly, in order to implement EPD/PPD on VCs which reside inside a VP switch it is required to identify in real time the VCIs (VCI, standing for VC identifier) inside the VP in spite of the fact that they are not configured. Moreover, considering the large numbers of VC in each VP (up to 4K VPs with 64K VCs in each), there is a need in the art to develop a very efficient data structure that can accommodate numerous EPD/PPD state machines (or data structures indicative thereof), in order to access and extract in an efficient manner a specific state machine of a sought VCI.

There is a further need in the art to provide for an EPD/PPD on VCs which reside inside a VP.

There is a further need in the art to provide for a data structure that would enable to store and access in an efficient manner an EPD/PPD state machine indicative of a VCI in a VP switch.

### SUMMARY OF THE INVENTION

In accordance with the invention there is provided for in an Electronic device including Asynchronous Transfer Mode (ATM) switching capabilities or including interior fixed length packet/cell processing for use in telecommunication networks, a method for buffering incoming cells of packets, the cells are assigned, each, within Virtual Path Identifier (VPI) and Virtual Channel Identifier (VCI), such that all cells of the same packet bear the same VCI; the method comprising:

a. associating each VCI with data that include data item serving for packet efficiency mechanism;

b. storing in a data structure selected number from said data items;

c. for each incoming cell whose VCI is associated with data item that is stored in said data structure, constructing a search key that enables to access said data item at substantially O(1).

There is further provided an electronic device including Asynchronous Transfer Mode (ATM) switching capabilities or including interior fixed length packet/cell processing for use in telecommunication networks, the electronic device includes a buffer of incoming cells of packets, the cells are assigned, each, within Virtual Path Identifier (VPI) and Virtual Channel Identifier (VCI), such that all cells of the same packet bear the same VCI; the device comprising:

a. each VCI is associated with data that include data item serving for packet efficiency mechanism

b. storage medium storing data representative of data structure for storing selected number from said data items;

c. processor associated with said storage medium configured to perform the processing that include: for each incoming cell whose VCI is associated with data item that is stored in said data structure constructing a search key that enables to access said data item at substantially O(1).

The invention further provides for: in an Electronic device including Asynchronous Transfer Mode (ATM) switching capabilities or including interior fixed length packet/cell processing for use in telecommunication networks, a program storage device readable by machine, tangibly embodying a program of instructions executable by the machine to perform method steps for buffering incoming cells of packets, the cells are assigned, each, within Virtual Path Identifier (VPI) and Virtual Channel Identifier (VCI), such that all cells of the same packet bear the same VCI; the method comprising:

a. associating each VCI with data that include data item serving for packet efficiency mechanism

b. storing in a data structure selected number from said data items;

c. for each incoming cell whose VCI is associated with data item that is stored in said data structure, constructing a search key that enables to access said data item at substantially O(1).

Still further the invention provides for: in an Electronic device including Asynchronous Transfer Mode (ATM) switching capabilities or including interior fixed length packet/cell processing for use in telecommunication networks, a computer program product comprising a computer useable medium having computer readable program code embodied therein for buffering incoming cells of packets, the cells are assigned, each, within Virtual Path Identifier (VPI) and Virtual Channel Identifier (VCI), such that all cells of the same packet bear the same VCI; the computer program product comprising:

computer readable program code for causing the computer to associate each VCI with data that include data item serving for packet efficiency mechanism;

computer readable program code for causing the computer to store in a data structure selected number from said data items;

computer readable program code for causing the computer to for each incoming cell whose VCI is associated with data item that is stored in said data structure, constructing a search key that enables to access said data item at substantially O(1).

### BRIEF DESCRIPTION OF THE DRAWINGS

For a better understanding, the invention will now be described, by way of example only, with reference to the accompanying drawings, in which:

FIG. 1 illustrates a typical packet structure, according to the prior art;

FIG. 2 illustrates a VC cell arrangement, according to the prior art;

FIG. 3 illustrates a VP cell arrangement, according to the prior art;

FIG. 4A-B illustrate two cell buffers employing a naive cell buffer management mechanism and an efficient packet management mechanism, respectively, according to the prior art;

FIG. 5 a data structure for implementing an EPD/PPD mechanism on a given VC, according to the prior art;

FIG. 6 illustrates an addressing scheme in accordance with a preferred embodiment of the invention;

FIG. 7 illustrates a memory structure for use with the efficient EPD/PPD addressing scheme, according to an embodiment of the present invention; and

FIG. 8 illustrates a generalized flow chart of the operational steps of a system, in accordance with an embodiment of the invention.

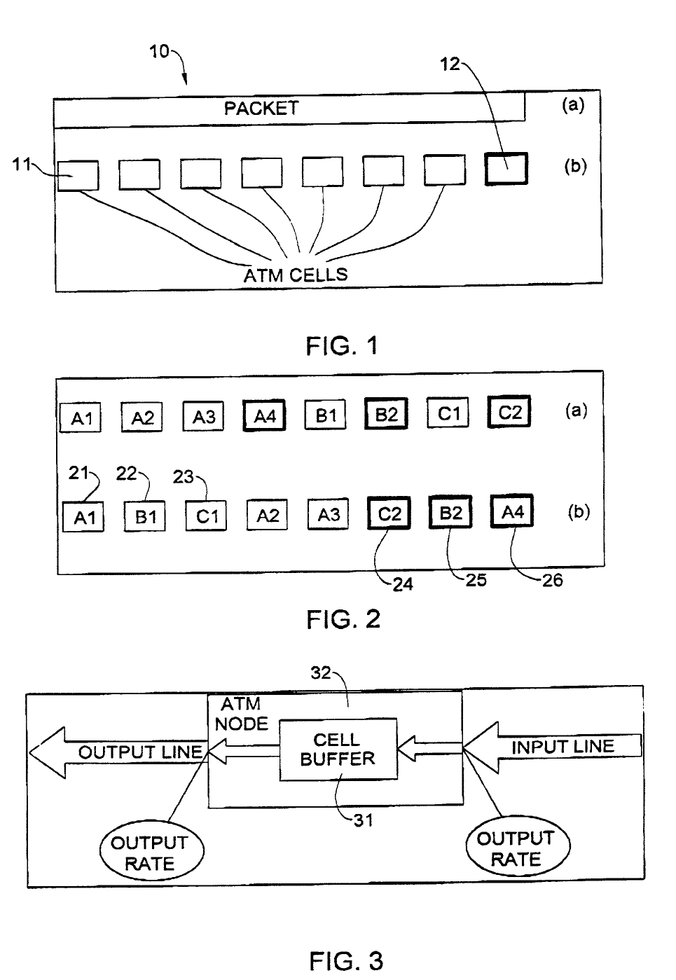

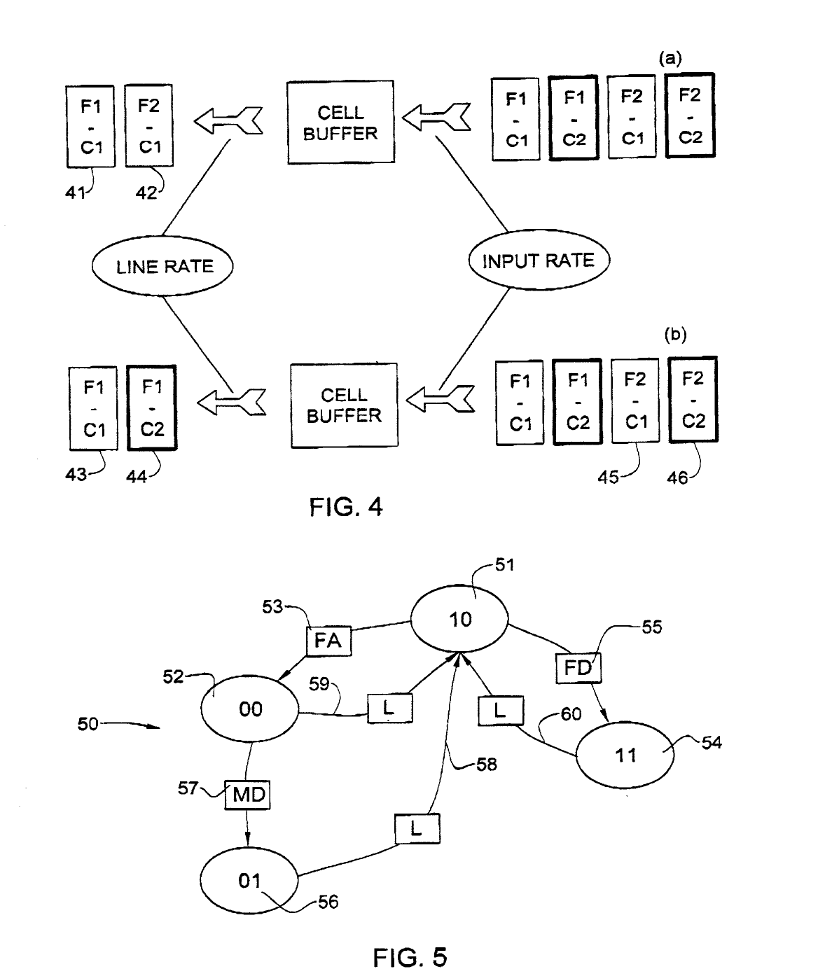

### DESCRIPTION OF PREFERRED EMBODIMENT

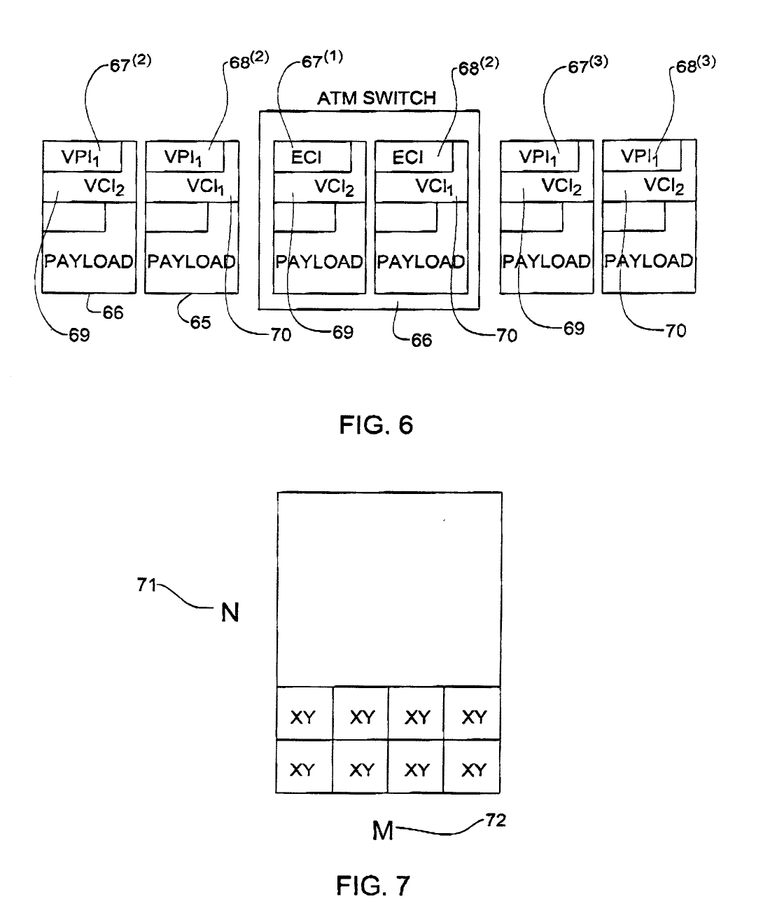

Turning now to FIG. 6, there is shown a typical, yet not exclusive, example of implementing an addressing scheme in a buffer that is incorporated in an Electronic device including Asynchronous Transfer Mode (ATM) switching capabilities or including interior fixed length packet/cell processing for use in telecommunication network, according to a preferred embodiment of the invention.

In accordance with this preferred embodiment, cells e.g. (65, 66) which enters the switch (66) are given an interim identifier, e.g. an ECI code (egress connection identifier). The ECI is defined during the configuration of the VP connection. As shown, the ECI code (67⁽¹⁾ and 68⁽¹⁾) “temporarily” overwrites a portion of the VPI of the specified cells (67⁽²⁾ and 68⁽²⁾, respectively). This, however, has no bearings on the overall operation of the electronic device and the other communication devices that operate therewith, considering that the VPI values are restored (see 67⁽³⁾ and 68⁽³⁾, respectively), using to this translation table (referred to also as Header Translation) before the data stream is delivered at the output of the switch. Therefore, communication devices that communicate with the switch and utilize the VPI are not affected.

A typical ECI code partially overlaps the VPI field. By another preferred embodiment, the ECI code can extend over any subset of the VPI field, or in other location.

The ECI will, thus, serve as VP identifier for any incoming cell. The reason that the original VPI is not used but rather is replaced by an interim code (e.g. the specified ECI code) is that the ECI serves as a component of a key for efficiently addressing a data structure that stores values, each indicative of data that includes the sought EPD/PPD machine. Whereas the VPI values of the respective incoming cells normally do not constitute a consecutive series, the ECI values are intentionally constructed as a consecutive series which, as will be explained in greater detail below, facilitate an efficient search for the sought VC machine.

Not only that due to the ECI code the data indicative of the VPI that corresponds to each cell is identified in an efficient manner, but also the original VCI value in the cell remains (see (69) and (70)), enabling thus a rapid access to the sought EPD/PPD machine. As will be shown below, the ECI/VCI values will constitute a search key enabling rapid access to the sought EPD/PPD state machines. In this way when the cell is admitted to the buffer, a corresponding key (by this embodiment the ECI and the VCI) to the data structure of the EPD/PPD state machines is available. It should be noted that whilst in the preferred embodiment a 2 bit data is used, representing an EPD/PPD state machine, the invention is not bound by this example. Thus, the 2 bits are only one example of representing data item. Moreover, the data item is not necessarily representing an EPD/PPD state machine and the latter is therefore regarded only as an example.

Turning now to FIG. 7, there is shown a storage data structure that facilitates access to the EPD/PPD state machines. In the specific embodiment of FIG. 7, there is shown an N (71) over M (72) memory array. It should be noted that the memory is depicted for illustrative purposes as a single M over N module, but those versed in the art will readily appreciate that many other known per se physical/logical arrangements of storage data structure are applicable.

Notice that the N over M value determines the number of VCIs that can be supported (with their respective EPD/PPD machines). Thus, the maximal number is N*M/2 (the division by 2 stems from the fact that by this preferred embodiment each state machine is represented in 2 bits).

As is well known under the ATM standard, the maximal number of VPs is 4K and the maximal number of VCs within each VP is 64K. The total space that is needed to store all potential EPD/PPDs amounts, thus, for 512 Mbits. Such a memory size is too large (and expensive) to be included in a commercially available fast access memory.

In accordance with the invention only a partial memory is allocated, say a memory of 256K×32 bit (constituting less memory space than the specified 4K over 64K multiplied by 2, which would otherwise be required in order to represent the whole possible VCs). Whilst, due to the limited memory size not all of the EPD/PPD state machines can be stored and accessed rapidly, a considerable number of such machines can be nevertheless accessed. As will be evident from the description below, those EPD/PPD state machines that are not stored in the specified fast memory, are accessed in other known per se (obviously slower) access techniques.

Notice that basically the size of the memory is what limits the number of VCIs that can be supported. Reverting now to the example of a memory size of is 256K×32, then 1K VCs can be supported for any one of the 4K VPs. However, the same memory can be easily configured to a different number of VCs and VPs. Thus, for example, the same memory can be configured to support 256 VPs with 16K VCs per VP. In accordance with another non-limiting example a 2K VPs over 2K VCs can be supported within the same memory arrangement. Thus, for the specific case of 2 bits representation per EPD/PPD state machine, if P is the number of VPs for which support is sought and C is the number of VCs within each VP the, following algorithmic expression applies: N*M/2=P*C.

In accordance with a preferred embodiment, the construction of the search key to the memory table will be as follows: the VP block is determined by the ECI code, e.g. by the configuration of the ECI field depicted in FIG. 6. Thus, the bits [log₂P:0] from the ECI field constitute the MSB of the key. The sought data (indicative of EPD/PPD state machine) within a VPI block is determined by the bits [log₂C:log₂M−1] of the VCI that constitute the LSB of the search key.

By a specific example, the search within a VPI block is realized by first determining the number of the row in the block (by considering the MSB bits of the VCI search key constituent) and the specific location within the row is determined by considering the LSB bits of the VCI search key constituent. By using the specified addressing scheme the EPD/PPD state machine (represented by 2 bits) is extracted virtually at O(1), thereby achieving a very efficient access scheme.

As specified above by this preferred embodiment the memory table can be easily configured to accommodate a different VPs and VCs (within each VP) provided, however, that the specified algorithmic expression applies. This reconfiguration may be applied in various scenarios. Thus, for example, if the memory is a priori configured to 256K×32 bits (supporting thus 1K VCs, [VCI #0 to VCI #1K−1] per each one of the 4K VPs) and it turns out that major portion of the incoming cells bear a VC # which exceed 1K−1 (and therefore the fast accesses mode is not applicable), the memory may be reconfigured to support more VCs in each VP with the inevitable penalty that less VPs are supported.

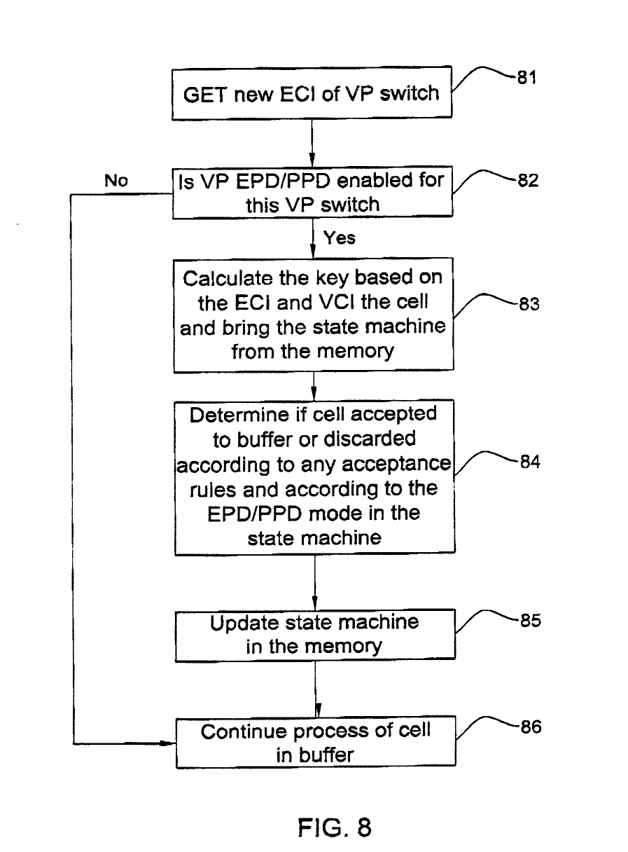

FIG. 8 describes a generalized algorithm for fast access to EPD/PPD state machine using the data structure of FIG. 7 in accordance with a preferred embodiment of the invention. Thus, an incoming cell is assigned with an available ECI code (normally a consecutive number), which, by this embodiment, overwrites a portion of the VPI field (as depicted in FIG. 6)—step (81). Thereafter, a test is performed in order to verify whether the VP EPD/PPD mode is enabled (82). If in the affirmative, the search key is calculated (83) by concatenation of the ECI and VCI key constituents. Having constructed the key, a search (at substantially O(1)) is conducted in order to locate in the memory the EPD/PPD machine that corresponds to the VPI/VCI of the incoming cell (84). In the case that the address key constitutes a valid address in the memory, this indicates that the memory stores the two bits of the EPD/PPD machine that corresponds to the sought cell. In this case the 2 bits are extracted, the cell is processed and the state machine is updated (step (85)), in accordance with the specific description of FIG. 5 above. Then, the updated state of the EPD/PPD machine is restored in the memory. If, on the other hand, no valid address is established by using the specified search key, this indicates that corresponding EPD/PPD machine is not stored in the memory and accordingly an alternative, (and obviously less efficient) mode of operation should be applied.

Having updated and stored in the memory the EPD/PPD state machine of the cell, the latter is further processed in the buffer, all as known per se (86). Reverting now to step (82), if the EPD/PPD mode is not triggered on, the EPD/PPD processing is skipped and the cell is subject to the other known per se processing steps in the buffer (86).

After having utilized the ECI in the manner specified, the appropriate VPI value is restored in accordance with a transformation table, all as known per se.

As is well known, in an ATM protocol the first 32 VCs in each VP are reserved for a predetermined use. Thus, it may be required to avoid any treatment in respect of the first 32 VCs (0-31) in each VP. One out of many possible variants to overcome this problem is simply to shift any VC value by 32. Thus, the EPD/PPD machine that resides in the first cell in each block does not represent VC #0, but rather VC #32 (after applying the offset by 32).

In the method claims that follow, alphabetic characters used to designate claim steps are provided for convenience only and do not imply any particular order of performing the steps.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity but those versed in the art will readily appreciate that various alterations and modifications may be carried out without departing from the scope of the following claims:

1. In an Electronic device including Asynchronous Transfer Mode (ATM) switching capabilities or including interior fixed length packet/cell processing for use in telecommunication networks, a method for buffering incoming cells of packets, the cells are assigned, each, within Virtual Path Identifier (VPI) and Virtual Channel Identifier (VCI), such that all cells of the same packet bear the same VCI; the method comprising:
(a) associating each VCI with data that include data item serving for packet efficiency mechanism;
(b) storing in a data structure selected number from said data items;
(c) for each incoming cell whose VCI is associated with data item that is stored in said data structure, constructing a search key that enables to access said data item at substantially O(1).

2. The method according to claim 1, wherein said data item indicates an EPD/PPD state machine.

3. The method according to claim 2, wherein said data item is 2-bit-long representing a packet efficiency mechanism realized as an EPD/PPD state machine.

4. The method according to claim 3, wherein said data structure being an N over M memory table.

5. The method according to claim 1, wherein said data structure being an N over M memory table.

6. The method according to claim 5, wherein the number of VPs accommodated in said memory being P and the number of VCs accommodated within said memory being L such that the following algorithmic expression applies: N*M/S=P*L, where S being the size of the data item.

7. The method according to claim 4, wherein the number of VPs accommodated in said memory being P and the number of VCs accommodated within said memory being L such that the following algorithmic expression applies: N*M/2=P*L.

8. The method according to claim 6, wherein said memory is configurable according to any P and L that meet said algorithmic expression.

9. The method according to claim 7, wherein said memory is configurable according to any P and L that meet said algorithmic expression.

10. The method according to claim 1, wherein said step (c) further including:
i) for each incoming cell assigning an interim code ECI, being a member of consecutive series, that is being indicative of the VPI;
ii) constructing a search key that includes said interim code ECI and VCI.

11. The method according to claim 10, wherein said search key is constructed by concatenating said ECI and VCI.

12. The method according to claim 10, wherein said ECI partially overwrites the VPI, and wherein there is provided the additional step of:
(d) restoring the VPI according to a translation table before the cell is delivered as an output from the buffer.

13. The method according to claim 1, further comprising a step of:
testing a triggering condition which determines whether or not to apply said step (c).

14. The method according to claim 1, wherein only data items with associated VCI value that exceeds 31 are stored in said data structure.

15. An Electronic device including Asynchronous Transfer Mode (ATM) switching capabilities or including interior fixed length packet/cell processing for use in telecommunication networks, the electronic device includes a buffer of incoming cells of packets, the cells arc assigned, each, within Virtual Path Identifier (VPI) and Virtual Channel Identifier (VCI), such that all cells of the same packet bear the same VCI; the device comprising:
(a) each VCI is associated with data that include data item serving for packet efficiency mechanism
(b) storage medium storing data representative of data structure for storing selected number from said data items;
(c) processor associated with said storage medium configured to perform the processing that include: for each incoming cell whose VCI is associated with data item that is stored in said data structure constructing a search key that enables to access said data item at substantially O(1).

16. The system according to claim 15, wherein said data item indicates an EPD/PPD state machine.

17. The system according to claim 16, wherein said data item is 2-bit-long representing a packet efficiency mechanism realized as an EPD/PPD state machine.

18. The system according to claim 17, wherein said data structure being an N over M table.

19. The system according to claim 15, wherein said data structure being an N over M table.

20. The system according to claim 19, wherein the number of VPs accommodated in said table being P and the number of VCs accommodated within said memory being L such that the following algorithmic expression applies: N*M/S=P*L, where S being the size of the data item.

21. The system according to claim 18, wherein the number of VPs accommodated in said table being P and the number of VCs accommodated within said memory being L such that the following algorithmic expression applies: N*M/2=P*L.

22. The system according to claim 20, wherein said table is configurable according to any P and L that meet said algorithmic expression.

23. The system according to claim 21, wherein said table is configurable according to any P and L that meet said algorithmic expression.

24. The system according to claim 15, wherein said processor is further configured to perform the processing:
i) for each incoming cell assigning an interim code ECI, being a member of consecutive series, that is being indicative of the VPI;
ii) constructing a search key that includes said interim code ECI and VCI.

25. The system according to claim 24, wherein said search key is constructed by concatenating said ECI and VCI.

26. The system according to claim 24, wherein said ECI partially overwrites the VPI, and wherein the processor is further configured to:
restoring the VPI according to a translation table before the cell is delivered as an output from the buffer.

27. The system according to claim 15, wherein said processor is further configured to:
testing a triggering condition which determines whether or not to apply said step (c).

28. The system according to claim 15, wherein only data items with associated VCI value that exceeds 31 is stored in said data structure.

29. In an Electronic device including Asynchronous Transfer Mode (ATM) switching capabilities or including interior fixed length packet/cell processing for use in telecommunication networks, a program storage device readable by machine, tangibly embodying a program of instructions executable by the machine to perform method steps for buffering incoming cells of packets, the cells are assigned, each, within Virtual Path Identifier (VPI) and Virtual Channel Identifier (VCI), such that all cells of the same packet bear the same VCI; the method comprising:
(a) associating each VCI with data that include data item serving for packet efficiency mechanism
(b) storing in a data structure selected number from said data items;
(c) for each incoming cell whose VCI is associated with data item that is stored in said data structure, constructing a search key that enables to access said data item at substantially O(1).

30. In an Electronic device including Asynchronous Transfer Mode (ATM) switching capabilities or including interior fixed length packet/cell processing for use in telecommunication networks, a computer program product comprising a computer useable medium having computer readable program code embodied therein for buffering incoming cells of packets, the cells are assigned, each, within Virtual Path Identifier (VPI) and Virtual Channel Identifier (VCI), such that all cells of the same packet bear the same VCI; the computer program product comprising:
computer readable program code for causing the computer to associate each VCI with data that include data item serving for packet efficiency mechanism;
computer readable program code for causing the computer to store in a data structure selected number from said data items;
computer readable program code for causing the computer to for each incoming cell whose VCI is associated with data item that is stored in said data structure, constructing a search key that enables to access said data item at substantially O(1).
